(19) United States
(12) Patent Application Publication
(10) Pub. No.: US 2004/0191599 A1
(43) Pub. Date: Sep. 30, 2004

(54) Highly discriminating, high throughput proton-exchange membrane for fuel-cell applications

(76) Inventors: Warren B. Jackson, San Francisco, CA (US); Yoocham Jeon, Palo Alto, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/401,635

(22) Filed: Mar. 27, 2003

(51) Int. Cl. H01M 8/10; C08J 5/22; H01M 8/16

(52) U.S. Cl. 429/30; 429/33; 429/13; 521/27

(57) ABSTRACT

Highly discriminating, inexpensive proton-exchange membranes that allow for relatively high flux of protons across the membrane. In one embodiment, an artificial lipid-bilayer membrane is created to include biological hydrogen-ion transport channels. The biological hydrogen-ion transport channels may alternatively be intact hydrogen-ion transport proteins, synthetic hydrogen-ion channel cores from hydrogen-ion transport proteins, or additional types of hydrogen-ion transport molecules that stably reside within a lipid-bilayer membrane.

### TECHNICAL FIELD

The present invention is related to proton-exchange-membrane-based fuel cells and, in particular, to a proton-exchange membrane (“PEM”) that includes biological hydrogen-ion channels.

### BACKGROUND OF THE INVENTION

Fuel cells have been used in a variety of different applications for many years. These applications have included power plants for space vehicles, satellites, remote monitoring devices, and other rather exotic applications in which the comparatively expensive energy production by fuel cells is more than offset by favorable characteristics, including absence of toxic byproducts, longevity, and low maintenance. Recently, with greater attention being paid to alternative fuels for automobiles and other motorized vehicles, storing energy from variable, renewable energy sources, and long-lived power sources for portable electronic devices, fuel-cell research has begun to gain increasing momentum. There are numerous types of fuel cells differing both in the fuels oxidized by the different types of fuel cells as well as in the catalysts used to facilitate oxidation of the fuel to provide for generation of electrical power. Most catalysts require high temperatures and are therefore expensive and not suitable for small-power-source applications such as mobile electronics. Particularly low operating temperatures are provided by a class of fuel cells that utilize proton exchange membranes. The proton exchange membrane prevents fuel from reaching the catalyst while providing sufficient proton flux to carry the current across the membrane.

FIG. 1 is a block diagram of a proton-exchange-membrane-based fuel cell. The PEM-based fuel cell shown in FIG. 1 includes a fuel reservoir 102, an oxidant reservoir 104, a proton-exchange membrane 106, and an anode 108 interconnected through an electrical interconnection 110 to a cathode 112. The anode 108 is suspended within the fuel reservoir 102, and the cathode 112 is suspended within the oxidant reservoir 104. The PEM 106 is a hydrated membrane that allows passage of protons from the fuel reservoir 102 to the oxidant reservoir 104. The PEM, however, is far less permeable to other ions, oxidants, and neutral small molecules, and, in the ideal case, impermeable to all but protons. The anode 108 is fashioned from a catalyst material, commonly including platinum, for catalyzing oxidation of methanol, CH₃OH, to carbon dioxide, CO₂. As shown in FIG. 1, the half-cell chemical equation for this oxidation reaction is:

CH₃OH+H₂0→CO₂+6e⁻++6H⁺

The electrons produced by oxidation of methanol to carbon dioxide, unable to pass through the PEM 106, instead flow from the anode 108 through the electrical interconnection 110 to the cathode 112. These electrons, and the catalyst material from which the cathode is made, commonly including platinum, allow for the reduction of oxygen to water according to the following half-cell chemical equation:

6H⁺+6e⁻+3/2O₂→3H₂O

The net equation for the oxidation of methanol by the fuel cell is:

CH₃OH+3/2O₂→CO₂+2H₂O

The oxidation of methanol is characterized by a relatively large negative free energy, and therefore proceeds spontaneously. Because of the relatively large negative free energy, useful work can be extracted from the electric current flowing through the interconnection between the anode 108 and the cathode 112. In FIG. 1, this work is symbolically represented by an electrical resistance 114 included in the circuit including the fuel cell and the interconnection 110, with the work expended in conducting current through the resistance ultimately resulting in outflow of heat 116 from the fuel cell to the environment.

FIG. 2 is a simplified representation of a currently available polymer-electrolyte fuel cell in which the oxidation of methanol to carbon dioxide is coupled to generation of electrical power. The polymer-electrolyte fuel cell (“PEFC”) 200 shown in FIG. 2 includes a fuel reservoir containing a dilute solution of methanol and water 202, a hydrated, polymer-based electrolyte and PEM 204, two platinum electrodes 206 and 208, an oxidant reservoir 210, and, optionally, an additional barrier 212 with a coolant chamber 214 for circulating coolant to draw heat from the PEFC. Currently, the DuPont polymer-based electrolyte Nafion® is commonly employed as the polymer-based electrolyte and PEM. Air, containing oxygen, is continuously input 216 to the oxidant reservoir, from which air and water 218 is continuously drawn. A methanol/water fuel solution is continuously input 220 to the fuel reservoir 202, and water and carbon dioxide 222 are continuously drawn from the fuel reservoir 202. The anode 206 and cathode 208 are electrically interconnected 224-225 with an electrical circuit into which electrical power is supplied by the PEFC 200.

Current PEFC technology has a number of deficiencies. First, it is important to carefully manage the water content and flux through the various components of the fuel cell. The polymer-based electrolyte (204 in FIG. 2) needs to be highly hydrated in order to facilitate a high flux of proton transport between the fuel reservoir 202 and the cathode 208. Protons are generally hydrated in solution, and transport of a proton through the combined polymer-based electrolyte and PEM necessarily involves transport of between one and three water molecules. Thus, water is continuously transported from the fuel reservoir to the oxidant reservoir 210. When too much water is allowed to accumulate in the cathode and oxidant reservoirs, the cathode can become flooded, and the efficiency of the catalyst may be greatly decreased as a result of the flooding. However, if too little water is transported through the polymer-based electrolyte and PEM, the polymer may become dehydrated, decreasing the flux of protons transported through the polymer and possibly disrupting or irreversibly damaging the polymer and interconnections of the polymer to the cathodes. A second disadvantage is that current polymer-based electrolyte/PEMs are more permeable to methanol molecules than is desirable. As a result, a greater than desirable quantity of methanol molecules crosses the polymer-based electrolyte and PEM from the methanol reservoir to the cathode. The methanol may then be oxidized directly at the cathode, short-circuiting the electrical circuit and robbing the electrical circuit of power. The methanol may also poison the cathode, and greatly diminish the level at which oxygen is reduced, again diminishing the amount of power supplied by the fuel cell to the external electronic circuit. A third disadvantage is that many of the currently employed polymer-based membranes are expensive, unstable over time, and unstable at elevated temperatures at which fuel cells may more efficiently operate. For these reasons, designers, manufactures, and users of fuel cells have recognized the need for inexpensive, highly discriminating PEMs that provide a high flux of protons transported across the PEM and that can operate over extended periods of time.

### SUMMARY OF THE INVENTION

The present invention provides highly discriminating, inexpensive proton-exchange membranes that allow for relatively high flux of protons across the membrane. In one embodiment of the present invention, an artificial lipid-bilayer membrane is created to include biological hydrogen-ion transport channels. The biological hydrogen-ion transport channels may alternatively be intact hydrogen-ion transport proteins, hydrogen-ion channel cores from hydrogen-ion transport proteins, synthetic hydrogen-ion channel cores based on hydrogen-ion channel cores from hydrogen-ion transport proteins, or additional types of hydrogen-ion transport molecules that stably reside within a lipid-bilayer membrane.

### BRIEF DESCRIPTION OF THE DRAWINGS

FIG. 1 is a block diagram of a proton-exchange-membrane-based fuel cell.

FIG. 2 is a simplified representation of a currently available polymer-electrolyte fuel cell in which the oxidation of methanol to carbon dioxide is coupled to generation of electrical power.

FIGS. 3A-C illustrate transport of a proton along a water wire comprising a sequence of hydrogen-bonded water molecules.

FIG. 4 illustrates a water wire within an alpha-helical region of the hydrogen-ion-transport protein gramicidin A.

FIG. 5 abstractly illustrates a gramicidin-A protein complex embedded within a cell membrane.

FIG. 6 illustrates a PEM comprising a lipid-bilayer membrane with embedded biological proton-transport channels.

FIG. 7 shows the components of a PEM that represents one embodiment of the present invention.

FIG. 8 shows a fuel cell, similar to the fuel cell shown in FIG. 2, with a three-layer PEM used as the electrolyte/PEM in place of the Nafion® electrolyte/PEM used in the fuel cells shown in FIG. 2.

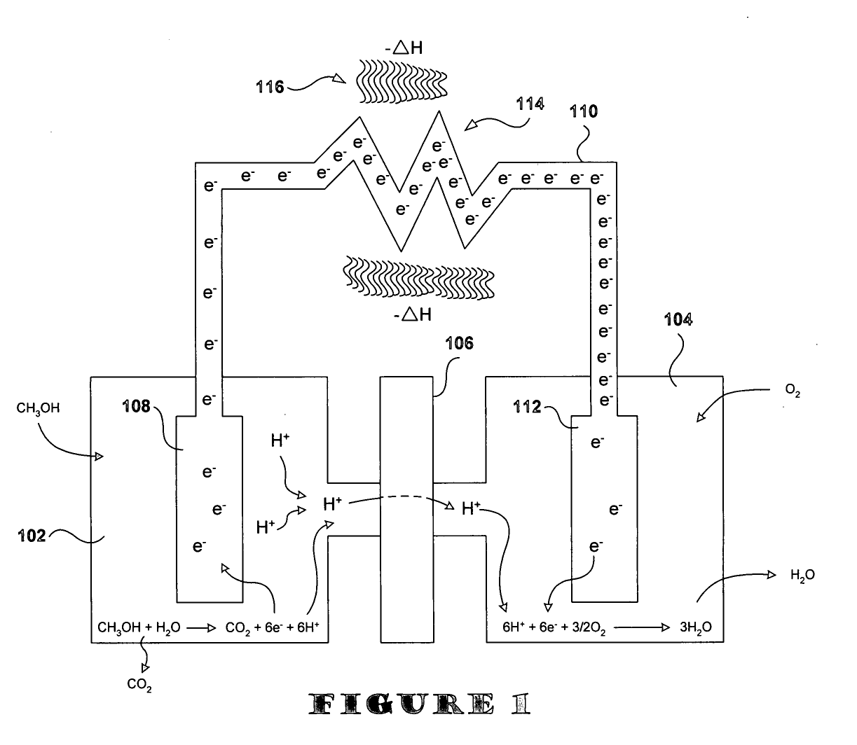

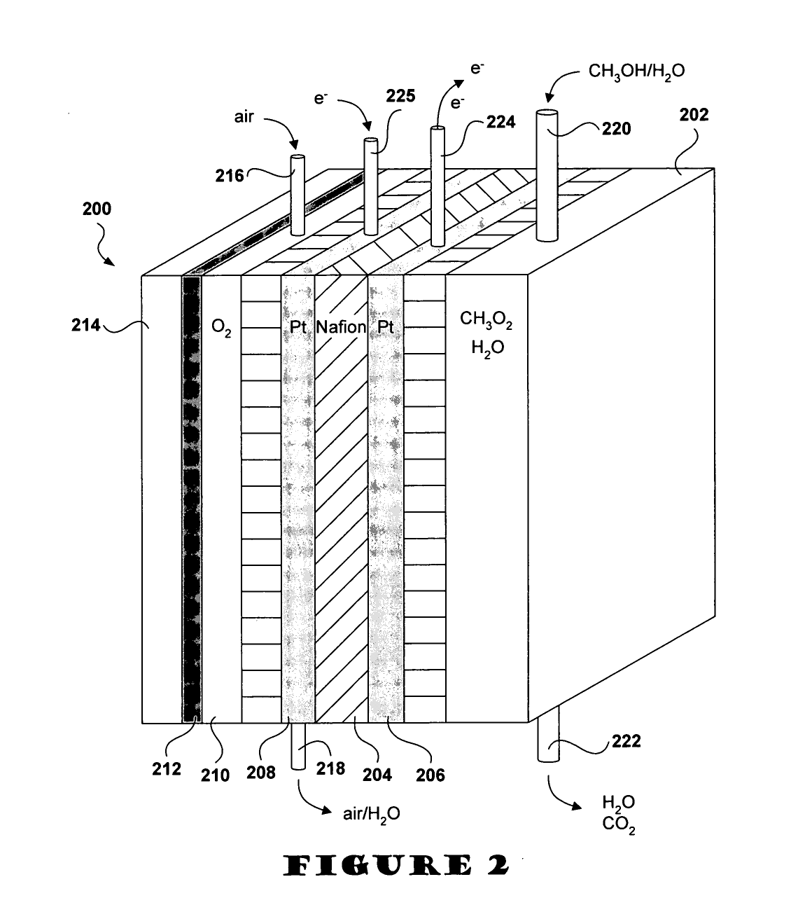

### DETAILED DESCRIPTION OF THE INVENTION

One embodiment of the present invention provides a highly discriminating proton-exchange membrane (“PEM”) that provides a high flux of hydrated protons across the PEM and that is particularly useful in fuel-cell application. In the described embodiment, the transport of hydrated protons across the PEM is driven by an electrochemical gradient produced between the electrodes of the fuel cell. The PEM provided as one embodiment of the present invention includes an artificial lipid-bilayer membrane similar to the lipid-bilayer membranes found in the cells of living organisms. Proton permeability is provided by biological or biologically derived hydrogen-ion channel molecules included in and spanning the artificial lipid-bilayer membrane.

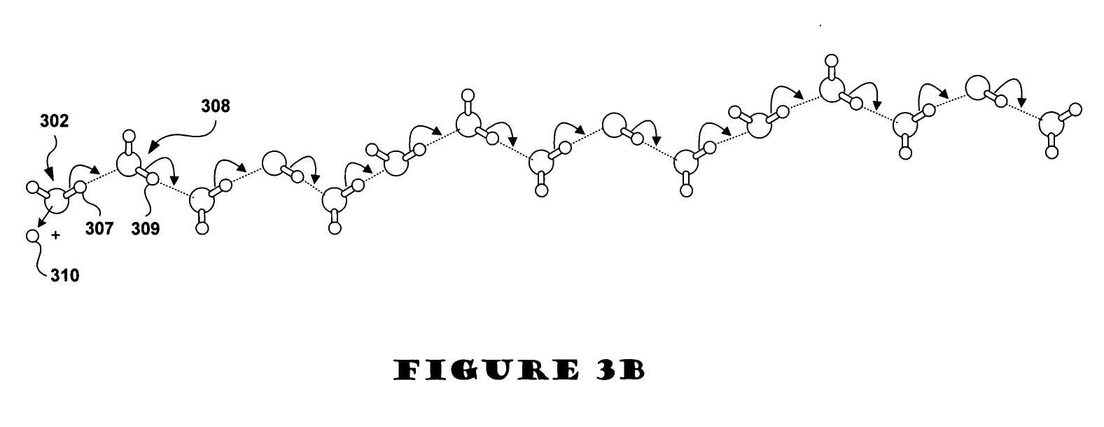

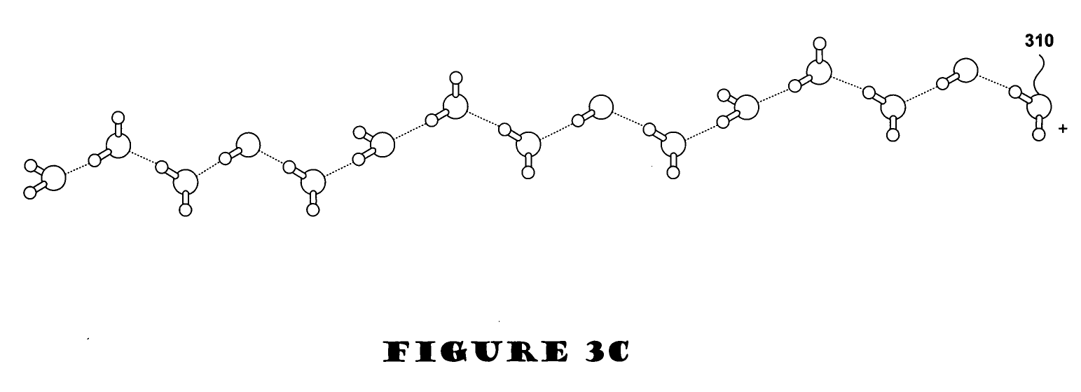

FIGS. 3A-C illustrate transport of a proton along a water wire comprising a sequence of hydrogen-bonded water molecules. FIG. 3A shows 15 water molecules bonded together in a chain via hydrogen bonds. Each water molecule, such as water molecule 302, comprises a central oxygen atom 304 and two hydrogen atoms 306-307. Water molecules have six valence electrons in the 2s and 2p orbitals. These valence electrons, along with the 1s orbitals of the two hydrogen atoms, combine to produce sp3-like molecular orbitals arranged in an approximately tetrahedral special organization about the oxygen atom. Two valence electrons are used in forming the two covalent bonds to hydrogen atoms, located as two vertices of the approximate tetrahedron, leaving four valence electrons that are not involved in covalent bonds. The four valence electrons are spatially and energetically partitioned into two lone pairs, forming the other two vertices of the approximate tetrahedron.

In liquid water, a hydrogen atom, such as hydrogen atom 307 in FIG. 3A, covalently bonded to an oxygen atom of a water molecule may also hydrogen bond through a lone pair associated with a second water molecule 308. In liquid water, water molecules arrange themselves in highly mobile and dynamic diamond-lattice-like cages via hydrogen bonding. The structure of ice is similar to the lattice structure of carbon atoms within diamonds. Protons are highly hydrated in liquid water, surrounded by a shell of water molecules with lone pairs oriented in the direction of the proton resulting in stabilization of the positive charge of the proton. Mass transport of hydrated protons through water requires the proton hydration complex to jostle, tumble, and collide with neighboring water molecules as the hydrated proton complex displaces water molecules along the path of transport. However, there is a much faster, alternative means for proton transport along sequences of hydrogen-bonded water molecules, called water wires, such as the sequence shown in FIG. 3A.

FIGS. 3B-C illustrate this second, more efficient transport of protons along a water wire. In FIG. 3B, the left-hand water molecule 302 attracts a proton 310 through one of the lone pairs of the water molecule 302. This attraction results in the formation of a positive charge on the water molecule, since lone-pair electrons are partially donated to the proton to form a bond. The water molecule can respond to this cumulated positive charge by releasing one of the other, covalently bonded hydrogen atoms 307. This, in turn, allows the next water molecule 308 along the water wire to more closely associate with the released hydrogen atom 307 and, in turn, release one of its covalently bonded hydrogen atoms 309. The same process is repeated along the chain, as shown in FIG. 3B. Finally, as shown in FIG. 3C, the release of covalently bonded hydrogen atoms results in the released hydrogen atoms becoming covalently bonded to the neighboring oxygen atom. The net result, as shown in FIG. 3C, is the transport of the positive charge, originally associated with the left-hand water molecule 302, to the right-hand water molecule 310. In each adjacent pair of oxygen atoms, the left-hand oxygen atom has released a previously covalently bonded hydrogen atom to its right-hand neighbor, but remains associated with the released hydrogen atom through a hydrogen bond. In other words, the transport of the proton from one end of the water wire to the other involves switching hydrogen bonds for covalent bonds along the chain of water molecules. Such electronic reconfiguration of water molecules can proceed at a much faster rate than mass transfer of hydrated proton complexes through bulk liquid. Importantly, there is no net transport of water molecules along with the hydrated proton.

FIG. 4 illustrates a water wire within an alpha-helical region of the hydrogen-ion-transport protein gramicidin A. Gramicidin A is a proton-transport protein that resides within cell membranes. It allows for passive diffusion of protons across the membrane. As shown in FIG. 4, a chain of water molecules, such as water molecule 402, is threaded through the central core of the alpha helix. In the three-dimensional structure of gramicidin, the core of the alpha helix is oriented in a direction roughly perpendicular to the plane of the cell membrane, and opens to both sides of the cell membrane, forming a passage through the cell membrane for the water wire of water molecules. Many other proton-transport membrane proteins are known.

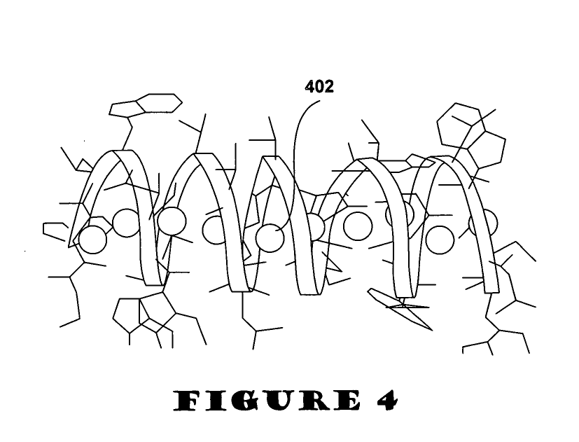

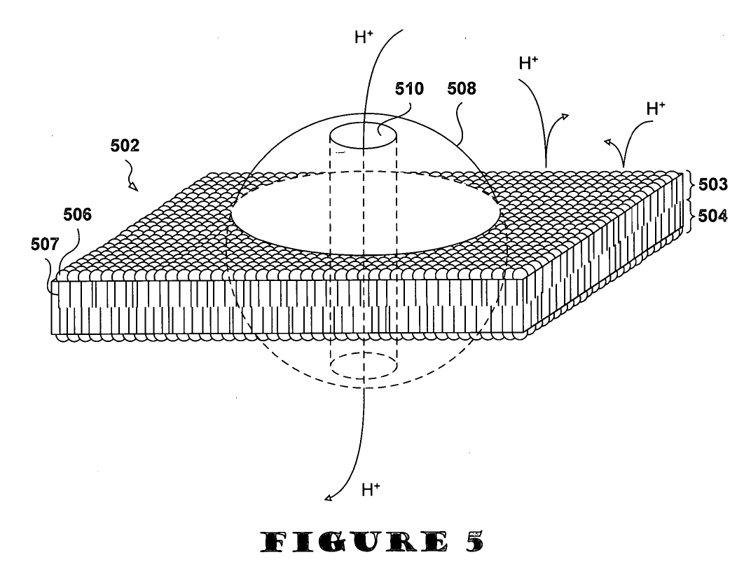

FIG. 5 abstractly illustrates a gramicidin-A protein complex embedded within a cell membrane. In FIG. 5, a small rectangular section 502 of the lipid-bilayer cell membrane is shown. The lipid-bilayer membrane 502 comprises two layers 503 and 504 of complex phospholipid molecules that include highly polar, and often charged, heads, such as polar head 506, and long, hydrophobic tails, such as tail 507. Lipid-bilayer membranes self assemble, with the hydrophobic tails of the phospholipid molecules oriented away from the external aqueous environment on both sides of the membrane to form a hydrophobic core, and the polar and often charged head groups forming outer layers on each side of the lipid-bilayer membrane to enable hydration of the charged and polar heads by water molecules in the aqueous environments on either side of the lipid-bilayer membrane. Lipid-bilayer membranes are essentially impermeable or only very slightly permeable to charged ions and to polar molecules. Such membranes allow for the compartmentalization of cells within an organism, with intercellular environments having quite different electrochemical properties than the external fluid environment of the issue in which the cell resides. In many cases, the proton concentration on one side of a cell membrane, within a cell, is quite different from the proton concentration on the other side of the cell membrane, external to the cell. Cells may actively transport protons across the cell membrane in order to establish an electrochemical gradient, using chemical energy stored in high-energy molecules, like adenosine-tri-phosphate, to pump protons across a cell membrane against an electrochemical gradient via active transport proteins and protein complexes embedded in the cell membrane. Passive proton-transport proteins, such as gramicidin A, facilitate transport of protons across cell membranes along an electrochemical gradient. As shown in FIG. 5, a gramicidin A protein complex 508 resides within a cell membrane 502, extending out into the aqueous environment on both sides of the cell membrane. The gramicidin A complex forms one or more pores 510 through the membrane that each accommodates a sequence of hydrogen-bonded water molecules that form a water wire. One end the pore 510 opens on a first side of the cell membrane, while the other end of the pore opens on the other side of the cell membrane. Thus, the presence of a gramicidin A protein complex embedded within the cell membrane provides a water-wire tunnel through which protons can be transported down a proton gradient from one side of a cell membrane to another without attendant water transport.

Recently, artificial lipid-bilayer membranes with proton-transport proteins oriented to provide transport of protons across the artificial lipid-bilayer membranes have been prepared for experimental purposes, as well as for commercial applications, including the manufacture of extremely sensitive biosensors. In one technique, gramicidin A molecules are tethered to a disulfide moiety through a polymer, and an ethanol solution containing tethered gramicidin A molecules is applied to a gold surface. The tethered gramicidin A molecules adhere to the gold surface via the disulfide groups to form a monolayer on the gold surface. Then, the layer of tethered gramicidin A molecules is exposed to a second ethanol solution containing phospholipid molecules, followed by rinsing with water, which causes the phospholipid molecules to spontaneously self assemble into a lipid-bilayer membrane in which the gramicidin A molecules are embedded. In another technique, a Langmuir-Blodgett monolayer of phospholipid molecules is created, and exposed to a bispecific antibody. The bispecific antibody binds to the phospholipid molecules, and also specifically binds to a specific portion of proton-transport protein. Additional phospholipid molecules can then be added to form a complete lipid-bilayer membrane with embedded, specifically-oriented proton-transport molecules. This technique thus allows for specific orientation of the proton-transport protein within the membrane, in the case that the proton-transport membrane transports protons in only one direction.

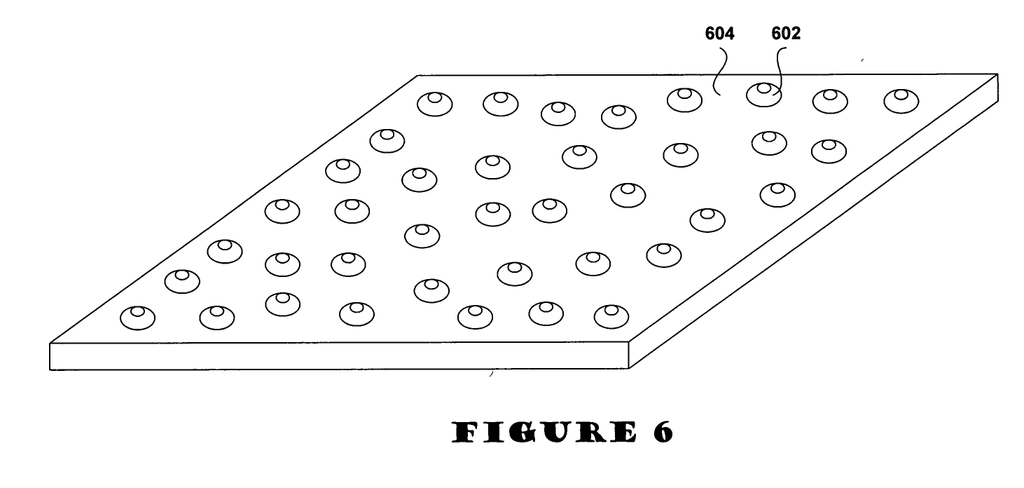

One embodiment of the present invention involves fabricating artificial membranes containing proton-transport membrane proteins for use as a PEM within a fuel cell. FIG. 6 illustrates a PEM comprising a lipid-bilayer membrane with embedded biological proton-transport channels. As shown in FIG. 6, the biological proton-transport molecules, such as proton-transport molecule 602, are embedded within a lipid-bilayer membrane 604. The proton-transport channels may be intact proton-transport membrane proteins, such as gramicidin A, or may be ion-channel subsequences of native proteins that are cloned and mass produced by fermentation processes. It is foreseeable that fully synthetic ion-transport channels may also be produced using biological ion-transport channels as models. Because of the enormous variety of ion transport channels existent in nature, these channels can be selected based on specific performance requirements. For example, complete synthetic ion-transport channels may have greater chemical and thermal stability, and may be resistant to degradation by bacterial and algal contaminants.

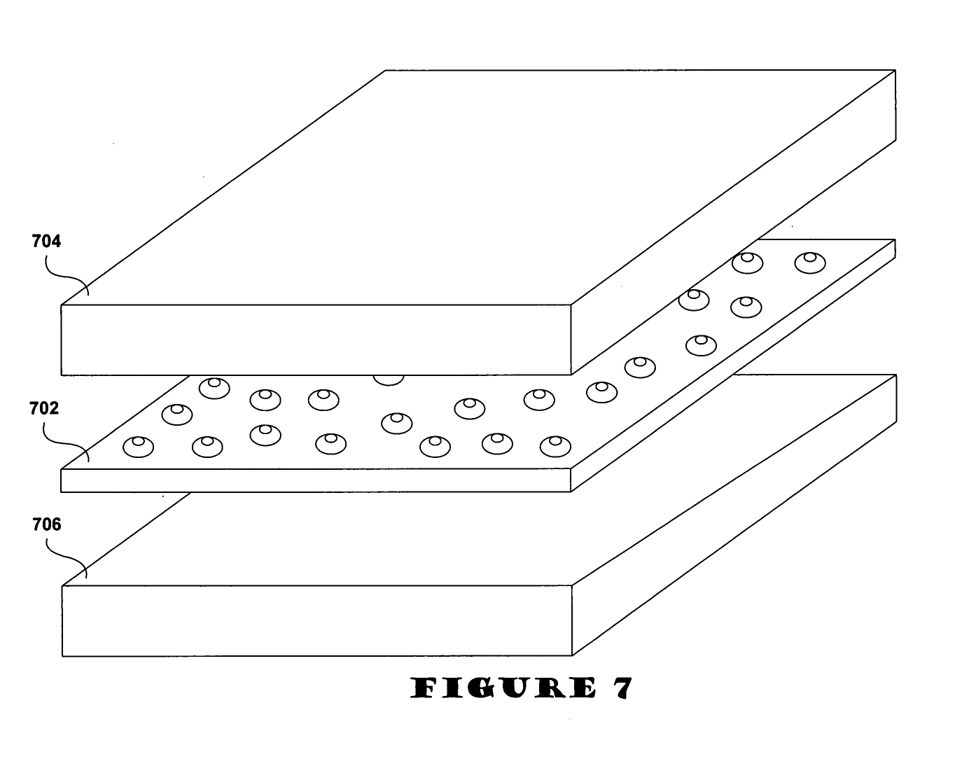

FIG. 7 shows the components of a PEM that represents one embodiment of the present invention. As shown in FIG. 7, the lipid-bilayer membrane containing biological or synthetic ion-transport channels 702 may be sandwiched between two hydrated, porous, polymer membranes 704 and 706 to provide for ease of handling and structural integrity of the complete three-layer PEM. Alternatively, lipid-bilayer membrane containing biological or synthetic ion-transport channels may be sandwiched between proton-porous metal films, natural, fibrous materials, ceramic materials, or other laminates or polymeric materials that provide mechanical protection to the lipid-bilayer membrane while also providing hydration and a high flux of protons.

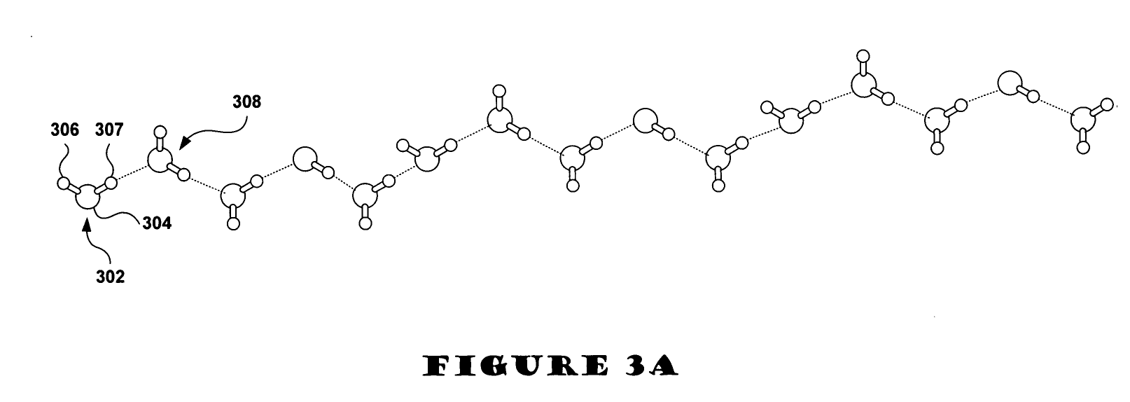

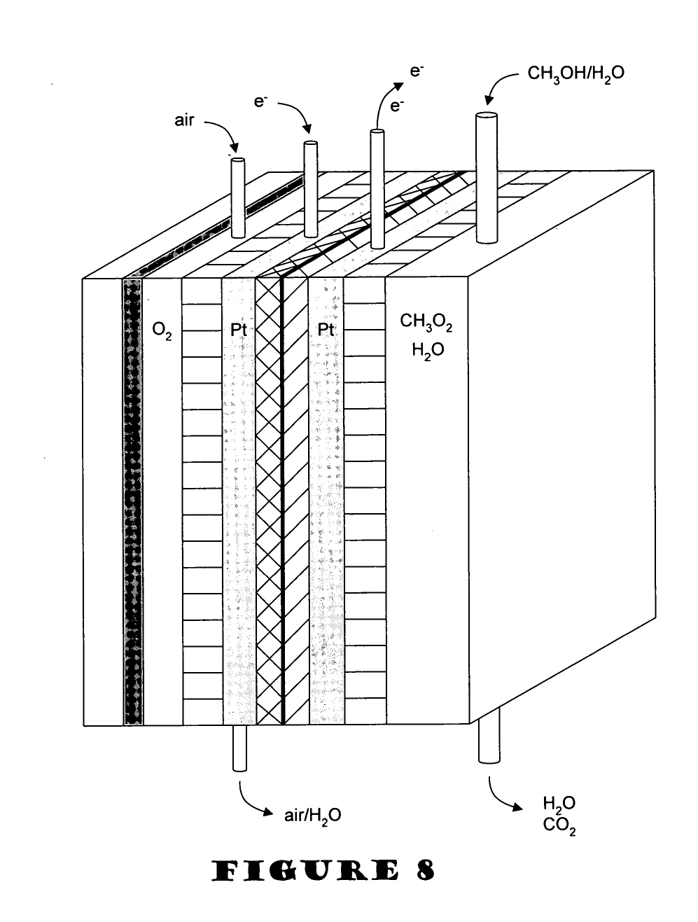

FIG. 8 shows a fuel cell, similar to the fuel cell shown in FIG. 2, with a three-layer electrolyte and PEM used as the electrolyte/PEM in place of the Nafion® electrolyte/PEM used in the fuel cells shown in FIG. 2. As noted above, any number of different layers of materials may be used to encase and protect the lipid-bilayer membrane. In certain applications, one electrode may be directly coated by a lipid-bilayer membrane, and placed within an aqueous or hydrated environment. Using an artificial lipid-bilayer membrane with embedded, biological or biologically derived proton-transport channels addresses the above-identified deficiencies of current PEMs and polymer-based electrolyte/PEMs. First, biological proton-transport channels may be quite inexpensively produced using well-known fermentation processes for growing bacteria genetically transformed to produce large quantities of the channels. The lipid-bilayer materials may also be biologically derived. Second, lipid-bilayer membranes with embedded proton-transport channels may provide a much higher flux of protons across the membrane, with a many-order-of-magnitude decrease in permeability towards methanol and other fuels. Third, use of membranes and proton-transport channels derived from hyperthermophyllic bacteria, such as Pyrodictium, which thrive in temperatures as high as 110C, or Thermus aquaticus, from which the heat tolerant Taq polymerase used in the polymerase chain reaction, may provide a PEM of much greater heat stability. Other ion channels of various species can handle chemical environments such as sulfurous or high pH environments that may occur when the fuel is contaminated with sulfur or acidic compounds. Finally, the ability of biological and biologically derived membranes to self assemble may allow for much easier maintenance and restoration of the membrane, and provide PEMs with greater operational lifetimes and greater reliability. In particular, if the membrane is sufficiently inexpensive, the PEM action can be continuously renewed by exposing new portions of the membrane during fuel cell operation. Such a capability would solve many lifetime, stability, and reliability issues associated with current polymer ion membranes.

Although the present invention has been described in terms of a particular embodiment, it is not intended that the invention be limited to this embodiment. Modifications within the spirit of the invention will be apparent to those skilled in the art. For example, any number of hundreds of different proton-transport proteins derived from any of millions of different types of organisms, or proton-transport channels derived from these biological sources or synthesized using the proton-transport proteins as models may be incorporated into artificial membranes. While lipid-bilayer membranes are attractive, other types of artificial membranes with hydrophobic cores may provide enhanced PEMs. As noted above, the proton-transport-channel-containing membranes may be sandwiched between layers of additional materials to provide structural integrity and to confer other, desirable characteristics to the PEM. Alternatively, the proton-transport-channel-containing membranes may be deposited directly onto electrodes, or may be deposited within porous, structural materials.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A proton-exchange membrane within a fuel cell, the proton-exchange membrane comprising:
a membrane; and
biological proton-transport channels embedded within the membrane.

2. The proton-exchange membrane of claim 1 wherein the membrane has a hydrophobic core and polar surfaces and wherein the membrane further comprises a self-assembling lipid-bilayer.

3. The proton-exchange membrane of claim 1 wherein the membrane further comprises a self-assembling layer of molecules having polar heads and hydrophobic tails.

4. The proton-exchange membrane of claim 1 wherein the biological proton-transport channels are proton-transport proteins.

5. The proton-exchange membrane of claim 1 wherein the biological proton-transport channels are core protein subsequences extracted from proton-transport protein sequences.

6. The proton-exchange membrane of claim 1 wherein the biological proton-transport channels are synthetic polymers based on the structures of proton-transport proteins.

7. The proton-exchange membrane of claim 1 further comprising:
layers of artificial materials between which the membrane with embedded proton channels is embedded.

8. The proton-exchange membrane of claim 7 wherein the layers of artificial materials are selected from among:
hydrated polymeric sheets;
porous metal films;
porous ceramic sheets, and
sheets of natural fibrous materials.

9. A method for generating electrical power, the method comprising:
providing a fuel cell containing proton-exchange membrane including embedded biological proton-transport channels;
introducing an oxidizable fuel on a first side of the proton-exchange membrane;
introducing an oxidant on the other side of the proton-exchange membrane; and
electrically electrically interconnecting an anode in contact with the oxidizable fuel to a cathode in contact with the oxidant through an electrical load.

10. The method of claim 9 wherein the proton-exchange membrane has a hydrophobic core and polar surfaces and wherein the proton-exchange membrane further comprises a self-assembling lipid-bilayer.

11. The method of claim 9 wherein the biological proton-transport channels are selected from among:
proton-transport proteins;
core protein subsequences extracted from proton-transport protein sequences; and
synthetic polymers based on the structures of proton-transport proteins.

12. A method for producing a fuel-cell proton-exchange membrane, the method comprising:
creating a membrane with low permeability to protons; and
embedding biological proton-transport channels into the membrane to produce a fuel-cell proton-exchange membrane.

13. The method of claim 12 wherein the membrane comprises a self-assembling layer of molecules having polar heads and hydrophobic tails.

14. The method of claim 12 wherein the biological proton-transport channels are proton-transport proteins.

15. The method of claim 12 wherein the biological proton-transport channels are core protein subsequences extracted from proton-transport protein sequences.

16. The method of claim 12 wherein the biological proton-transport channels are synthetic polymers based on the structures of proton-transport proteins.

17. The method of claim 12 wherein further comprising:
laminating the membrane with embedded biological proton channels between layers of artificial materials to increase the mechanical strength of the membrane.

18. The method of claim 12 the wherein the layers of artificial materials are selected from among:
hydrated polymeric sheets;
porous metal films;
porous ceramic sheets, and
sheets of natural fibrous materials.
